(19) United States
(12) Patent Application Publication
(10) Pub. No.: US 2023/0388004 A1
(43) Pub. Date: Nov. 30, 2023

(54) METHOD AND APPARATUS FOR INCIDENT MANAGEMENT FOR UAV SWARM

(71) Applicant: Lenovo (Beijing) Limited, Beijing (CN)

(72) Inventors: Jie Hu, Changping District (CN); Jing Han, Chaoyang District (CN); Haiming Wang, Xicheng District (CN); Min Xu, Haidian District (CN)

(73) Assignee: Lenovo (Beijing) Limited, Beijing (CN)

(21) Appl. No.: 18/026,428

(22) PCT Filed: Sep. 18, 2020
(86) PCT No.: PCT/CN2020/116169

§ 371 Date: Mar. 15, 2023

(51) Int. Cl. H04B 7/185; H04W 24/04; H04W 76/19

(52) U.S. Cl. CPC H04B 7/18502; H04W 24/04; H04W 76/19; B64U 10/00

(57) ABSTRACT

A method of incident management performed by a first UAV UE in a UAV swarm, the method includes: transmitting one or more incident reports; and if a recovery command for the first UAV UE is received, performing a recovery operation according to the recovery command.

### TECHNICAL FIELD

Embodiments of the present application generally relate to wireless communication technology, especially to a method and apparatus for incident management for an unmanned aerial vehicle (UAV) swarm.

### BACKGROUND

Reliable information exchange (e.g. position information for collaboration or collision avoidance) is necessary for a UAV swarm in formation maintenance and optimization. Considering the highly dynamic topology which may cause frequent breaks in radio connectivity, a UAV user equipment (UE) in the UAV swarm may encounter various incidents when performing tasks, e.g. deviating from flight path, falling behind etc. The consequence is that relative positioning among UAV UEs in the UAV swarm will be changed. For example, if inter-UAV spacing is too close, the interference or even collision between UAV UEs may be caused; if inter-UAV spacing is too excessive, the abnormal sidelink communication between the UAV UEs in the UAV swarm may be caused and information exchange between the UAV UEs in the UAV swarm may be blocked. All these incidents will make the UAV swarm application lose its advantage in industrial, agricultural or military fields. Therefore, inter-UAV spacing control is necessary for a UAV swarm in formation maintenance and optimization.

In addition, due to the restriction of transmitting distance, battery and swarming algorithm, a self-organized UAV swarm has a limited capability in detecting above incidents on inter-UAV spacing and recovering from them. Then the abnormal UAV UEs may have difficulty in catching up the swarm without further assistance. To some extent, swarm formation algorithm optimization or UE implementation in application layer may handle the problem, but it has limitation on quick reaction for inter-UAV spacing control. To address the problems and make more efficient work for a UAV swarm, the incident detection and recovery on inter-UAV spacing from access stratum (AS) layer should be considered in a 3GPP specification.

### SUMMARY OF THE APPLICATION

Embodiments of the present application provide a method and apparatus for incident management for a UAV swarm.

An embodiment of the present application provides a method of incident management performed by a first UAV UE in a UAV swarm. The method may include: transmitting one or more incident reports; and if a recovery command for the first UAV UE is received, performing a recovery operation according to the recovery command.

In an embodiment of the present application, each incident report comprises at least one of: a location of the first UAV UE; a first ID of the first UAV UE; a distance between the first UAV UE and a second UAV UE in the UAV swarm; sidelink power received by the first UAV UE from the second UAV UE; a second ID of the second UAV UE; and a cell ID of the second UAV UE.

In an embodiment of the present application, the second UAV UE is a neighboring UAV UE of the first UAV UE, a member UAV UE in the UAV swarm or a master UAV UE in the UAV swarm.

In an embodiment of the present application, the one or more incident reports are transmitted when an incident detection condition is met, and the incident detection condition comprises at least one of the following: the received sidelink power or a change of the received sidelink power is out of a first specified range; the distance between the first UAV UE and the second UAV UE or a change of the distance is out of a second specified range; and a sidelink radio link failure between the first UAV UE and the second UAV UE happens.

In an embodiment of the present application, the method may further include: receiving an incident detection configuration from a master UAV UE or a base station (BS).

In an embodiment of the present application, the method may further include: transmitting a location report after performing the recovery operation.

In an embodiment of the present application, the method may further include: receiving an incident detection configuration for one or more UAV UEs in the UAV swarm from a BS; receiving the one or more incident reports from the one or more UAV UEs in the UAV swarm; receiving a recovery indication indicating an abnormal UAV UE in the UAV swarm from the BS; and transmitting a recovery command to the abnormal UAV UE based on the recovery indication.

In an embodiment of the present application, the recovery command comprises at least one of the following: at least one of direction information and velocity information for the abnormal UAV UE; an expected position for the abnormal UAV UE; and a timing trigger for the abnormal UAV UE to transmit a location report.

In an embodiment of the present application, the method may further include: receiving the location report from the abnormal UAV UE in response to the recovery command; and transmitting the location report to the BS.

In an embodiment of the present application, the method may further include: determining whether recovery of the abnormal UAV UE is successful based on at least one of a measured sidelink power received by the first UAV UE from the abnormal UAV UE and the received incident report; and transmitting a recovery result to the BS.

Another embodiment of the present application provides a method of incident management performed by a first BS. The method may include: receiving one or more incident reports of one or more UAV UE in a UAV swarm; and identifying an abnormal UAV UE in the UAV swarm based on the one or more incident reports.

In an embodiment of the present application, the one or more incident reports are received from one or more UAV UE directly or via a master UAV UE.

In an embodiment of the present application, the method may further include: transmitting a recovery command to the abnormal UAV UE by radio resource control (RRC) signaling.

In an embodiment of the present application, the method may further include: transmitting a recovery indication indicating the abnormal UAV UE to a second BS, if the abnormal UAV UE is in a serving range of the second BS.

In an embodiment of the present application, the method may further include: initiating radio access network (RAN) paging or core network (CN) paging to find the abnormal UAV UE; and transmitting a recovery command to the abnormal UAV UE if the abnormal UAV UE is successfully paged in a serving range of the first BS.

In an embodiment of the present application, the method may further include: transmitting a recovery indication indicating the abnormal UAV UE to a master UAV UE.

In an embodiment of the present application, the recovery command or recovery indication comprises at least one of the following: at least one of direction information and velocity information for the abnormal UAV UE; an expected position for the abnormal UAV UE; and a timing trigger for the abnormal UAV UE to transmit a location report.

In an embodiment of the present application, the method may further include: receiving the location report of the abnormal UAV UE; and determining whether recovery of the abnormal UAV UE is successful.

In an embodiment of the present application, the method may further include: if the location report indicates the recovery of the abnormal UAV UE is not successful, transmitting an incident indication to inform the UAV swarm about the incident of the abnormal UAV UE.

In an embodiment of the present application, the method may further include: triggering a timer for the location report; and transmitting an incident indication to inform the UAV swarm about the incident of the abnormal UAV UE when the timer expires and no location report is received.

In an embodiment of the present application, the incident indication includes at least one of a third ID of the abnormal UAV UE, location information of the abnormal UAV UE, and an indication to clear the transmission with the abnormal UAV UE.

Another embodiment of the present application provides an apparatus. The apparatus may include at least one non-transitory computer-readable medium having computer executable instructions stored therein; at least one receiver; at least one transmitter; and at least one processor coupled to the at least one non-transitory computer-readable medium, the at least one receiver and the at least one transmitter. The computer executable instructions are programmed to implement the above method with the at least one receiver, the at least one transmitter and the at least one processor.

The embodiments of the present application can make the incident detection and recovery on inter-UAV spacing more efficiently from AS layer.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application;

FIG. 2 illustrates another wireless communication system according to some embodiments of the present application;

FIG. 3 illustrates a flow chart of a method for incident management for a UAV swarm according to some embodiments of the present application;

FIG. 4 illustrates a flow chart of another method for incident management for a UAV swarm according to an embodiment of the present application;

FIG. 5 illustrates an apparatus according to some embodiments of the present application; and

FIG. 6 illustrates another apparatus according to some other embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings.

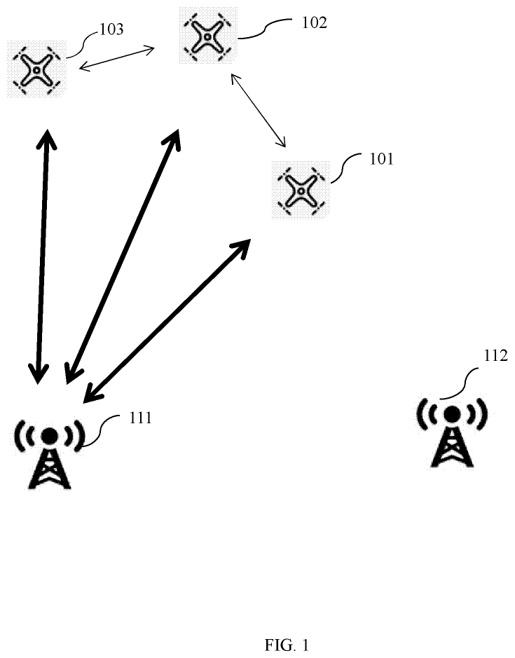

FIG. 1 illustrates a wireless communication system according to some embodiments of the present application.

As shown in FIG. 1, the wireless communication system can include at least one BS and at least one UAV swarm. Although a specific number of BSs and UAV swarms, e.g., two BSs (e.g., BS 111 and BS 112) and a UAV swarm (e.g., including three UAV UEs, that is, UAV UE 101, UAV UE 102, and UAV UE 103) are depicted in FIG. 1, one skilled in the art will recognize that any number of the BSs and the UAV swarms (including any number of UAV UEs) may be included in the wireless communication system.

A UAV swarm can be seen as a logic group of UAV UEs which managed by network. In the wireless communication system as shown in FIG. 1, the UAV UE 101, the UAV UE 102, and the UAV UE 103 in the UAV swarm may connect to the BS 111. The UAV UEs have a capability to communicate with the BS 111 via Uu interface, and can communicate with each other by using sidelink.

In FIG. 1, the UAV UE 101, the UAV UE 102, and the UAV UE 103 are all in the serving range of the BS 111, and the BS 111 may control the UAV UEs in its serving range to perform incident management-related operation(s) (for example, incident detection and incident recovery) on inter-UAV spacing according to the embodiments of the present application. In another case, with the movement of the UAV UE(s), one or more UAV UEs may be in the serving range of the BS 112, and the BS 112 may control the UAV UE(s) in its serving range to perform the incident management-related operation(s) on inter-UAV spacing according to the embodiments of the present application. The BS 111 and the BS 112 may communicate with each other via an interface X2/Xn.

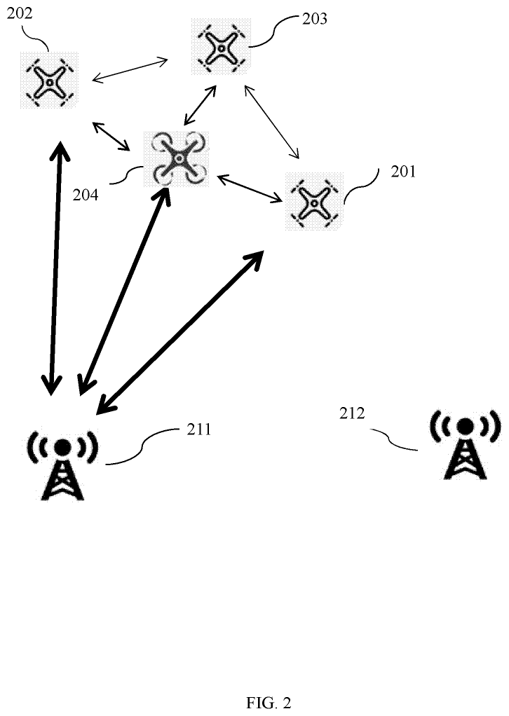

FIG. 2 illustrates another wireless communication system according to some embodiments of the present application.

As shown in FIG. 2, the wireless communication system can include at least one BS and at least one UAV swarm. Although a specific number of BSs and UAV swarms, e.g., two BSs (e.g., BS 211 and BS 212) and a UAV swarm (e.g., including four UAV UEs, that is, UAV UE 201, UAV UE 202, UAV UE 203, and UAV UE 204) are depicted in FIG. 2, one skilled in the art will recognize that any number of the BSs and the UAV swarms (including any number of UAV UEs) may be included in the wireless communication system.

In the wireless communication system as shown in FIG. 2, the UAV UE 204 is a master UAV UE and has a capability to communicate with the BS 211, and other UAV UEs (that is, the UAV UE 201, the UAV UE 202, and the UAV UE 203) in the UAV swarm can either communicate with the master UAV UE 204 or communicate with the BS 211 directly. The UAV UEs (including the master UAV UE 204) can communicate with the BS 211 via Uu interface, and can communicate with each other by using sidelink.

In FIG. 2, the UAV UE 201, the UAV UE 202, the UAV UE 203, and the UAV UE 204 are all in the serving range of the BS 211, and the BS 211 may control these UAV UEs in its serving range to perform incident management-related operation(s) (for example, incident detection and incident recovery) on inter-UAV spacing according to the embodiments of the present application. In another case, with the movement of the UAV UE(s), one or more UAV UEs may be in the serving range of the BS 212, and the BS 212 may control the UAV UE(s) in its serving range to perform the incident management-related operation(s) on inter-UAV spacing according to the embodiments of the present application. The BS 211 and the BS 212 may communicate with each other via an interface X2/Xn.

In some embodiments of the present application, the BS (for example, the BS 111, the BS 112 as shown in FIG. 1, the BS 211, the BS 212 as shown in FIG. 2) may also be referred to as an access point, an access terminal, a base, a base unit, a macro cell, a Node-B, an evolved Node B (eNB), a gNB, a Home Node-B, a relay node, or a device, or described using other terminology used in the art.

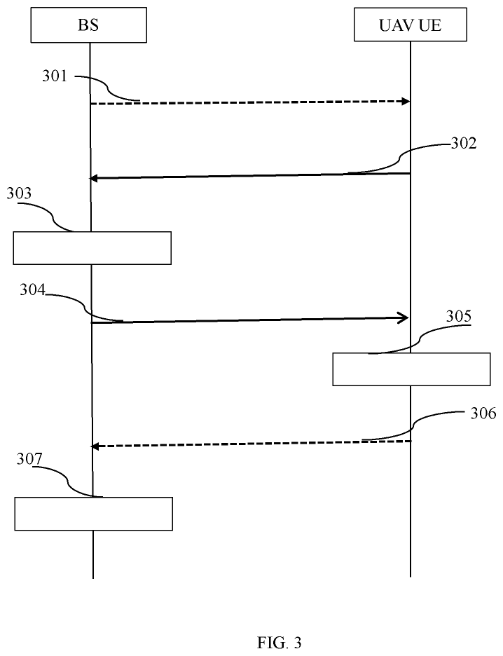

FIG. 3 illustrates a flow chart of a method for incident management for a UAV swarm according to some embodiments of the present application. The method in FIG. 3 may be performed between a BS (such as, the BS 111 or the BS 112 in FIG. 1) and the UAV swarm (including the UAV UE 101, the UAV UE 102 and the UAV UE 103 in FIG. 1) in the wireless communication system in FIG. 1. In FIG. 3, the UAV UE may indicate any one of the UAV UEs (for example, any one of the UAV UE 101, the UAV UE 102 and the UAV UE 103 in FIG. 1). The UAV UE 101, the UAV UE 102 and the UAV UE 103 in the UAV swarm may also be called a UAV UE member in a UAV swarm.

The BS may configure each UAV UE in the UAV swarm to perform incident detection on inter-UAV spacing. In step 301, the BS may provide incident detection configuration for each UAV UE to each UAV UE in the UAV swarm by using Uu interface.

The incident detection configuration from the BS to the UAV UE can be transmitted by dedicated radio resource control (RRC) signaling or can be broadcasted by system information block (SIB) signaling.

In another embodiment, in the case that the BS does not provide the incident detection configuration to each UAV UE and the incident detection configuration may be pre-configured in each UAV UE in the UAV swarm. For example, the incident detection configuration may be pre-configured in the UAV UE in the UAV swarm in the case that the UAV UE is out of the coverage of the BS.

The incident detection configuration may include the spacing between UAV UEs in UAV swarm. In an example, the inter-UAV spacing can be a common value among UAV UEs in the UAV swarm. In another example, the inter-UAV spacing can be a specific value to each UAV pairs in the UAV swarm. The spacing between UAVs in UAV swarm may be configured or controlled by the BS.

In addition, the incident detection configuration may further include incident detection condition(s) on inter-UAV spacing in the UAV swarm. The incident detection condition(s) on inter-UAV spacing may be configured by the BS (network) for the UAV UE member in the UAV swarm or pre-configured in the UAV UE member.

In step 302, a UAV UE may transmit an incident report to the BS based on the received incident detection configuration.

In an embodiment, each UAV UE in the UAV swarm transmits its location information periodically by broadcast or groupcast signaling. In another embodiment, each UAV UE in the UAV swarm reports its location information periodically to the BS. The location information may contain coordinate of latitude, longitude, and height and velocity information. After receiving the location information, the BS may detect the incidents on spacing between UAV UEs in the UAV swarm which will be described in detail in the following.

In another embodiment, each UAV UE may measure sidelink-reference signal received power (SL-RSRP) and/or distance information between the UAV UE itself and its neighboring UAV UEs in the UAV swarm. Each UAV UE may transmit an incident report to the BS when at least one of the following incident detection conditions is met:
The SL-RSRP or the change of SL-RSRP between the UAV UE itself and its neighboring UAV UE is within or outside a specified range during a time period;
The distance or the change of distance in horizontal or vertical between the UAV UE itself and its neighboring UAV UE is within or outside a specified range during a time period; and
A sidelink radio link failure between the UAV UE itself and its neighboring UAV UE happens (or is declared).

In this embodiment, the incident report may include the location of the UAV UE, the ID of an abnormal UAV UE and corresponding cell ID, and measurement result(s). The measurement result may include the measured SL-RSRP, the change of the SL-RSRP, the measured distance, the change of distance, or sidelink radio link failure report, etc.

The incident report from the UAV UE to the BS can be transmitted by RRC signaling, or be transmitted by broadcast or groupcast signaling.

After receiving the incident report(s) from the UAV UE(s) in the UAV swarm, the BS may assist the abnormal UAV UE(s) to perform quick recovery.

In step 303, the BS identifies the abnormal UAV UE(s) based on the received incident report(s).

In an embodiment of the present application, if the cell ID corresponding to the abnormal UAV UE in the incident report indicates the abnormal UAV UE is in the serving range of the BS, the BS transmits a recovery command to the abnormal UAV UE.

In another embodiment of the present application, if the cell ID corresponding to the abnormal UAV UE in the incident report indicates the abnormal UAV UE is not in the serving range of the BS (such as, the BS 111 in FIG. 1), the BS transmits a recovery indication to another BS (such as, the BS 112) which the abnormal UAV UE currently camped in by X2/Xn interface. The recovery indication is used to inform the serving BS (such as, the BS 112) of the abnormal UAV UE, so as to assist the abnormal UAV UE to perform recovery. The recovery indication includes the similar content with the recovery command which will be described in following.

In yet another embodiment of the present application, if the cell ID corresponding to the abnormal UAV UE in the incident report indicates the abnormal UAV UE is not in the serving range of the BS (such as, the BS 111 in FIG. 1), the BS initiates radio access network (RAN) paging or core network (CN) paging to find the abnormal UAV UE, and if the abnormal UAV UE is successfully paged in a serving range of the BS, the BS transmits a recovery command to the abnormal UAV UE.

For performing recovery to the abnormal UAV UE within its serving range when the abnormal UAV UE is identified, in step 304, the BS transmits a recovery command to the abnormal UAV UE to perform recovery by dedicated RRC signaling.

In an embodiment of the present application, the recovery command may include a recovery indication to specific abnormal UAV UE. The recovery indication can either be required direction information (e.g. offset value of longitude, latitude and height), or can be required velocity information (e.g. value on deceleration or acceleration).

In another embodiment of the present application, the recovery command may include the expected positions at a specified time X, which means the abnormal UAV UE can re-join the UAV swarm if it can reach the expected position at the time X.

In yet embodiment of the present application, the recovery command may include a timer for timing trigger for location report, which may contain latitude, longitude, height and velocity information. Such a timer for a location report can be configured in the BS and the UAV UE. For example, the timer starts upon a recovery command is transmitted by the BS. The timer stops upon a location report from an abnormal UAV UE is received by the BS due to another existing trigger. Upon the timer expires, the abnormal UAV UE triggers a location report to the BS.

After receiving the recovery command, in step 305, the abnormal UAV UE performs the recovery operation according to the recovery command.

And then in step 306, when the timer expires, the abnormal UAV UE triggers a location report to the BS.

In step 307, after receiving the location report(s) from the abnormal UAV UE(s), the BS may determine whether the recovery is successful or not. In an example, the location report indicates the abnormal UAV UE is in the expected position in the UAV swarm, and the BS may determine the recovery is successful; otherwise the BS may determine the recovery is unsuccessful.

In some cases, in an example, the abnormal UAV UE receives the recovery command but cannot perform the recovery operation, for example, due to current capability limitation. In another example, the abnormal UAV UE cannot receive the recovery command from the BS, for example, due to the occurred incident.

In these cases, the timer for the location report (which is the same timer as that included in the recovery command) can be triggered, and the BS may transmit an incident indication to inform the UAV swarm about the incident of the abnormal UAV UE when the timer expires and no location report is received. The incident indication may include the ID of the abnormal UAV UE, location information of the abnormal UAV UE, and an indication to clear the transmission with the abnormal UAV UE. In another example, the BS may inform application layer for the UAV swarm about the incident indication. The incident indication from the BS to the UAV swarm can be broadcasted by SIB signaling or be transmitted by RRC signaling. Furthermore, if the number of incidents on spacing occurred in the same UAV UE reaches to a specified value, the BS may inform application layer to drop out the UAV UE.

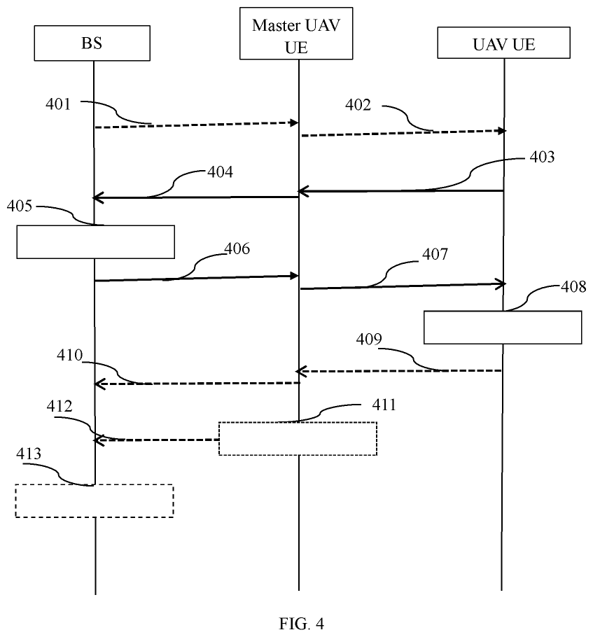

FIG. 4 illustrates a flow chart of another method for incident management in a UAV swarm according to some embodiments of the present application. The method in FIG. 4 may be performed among a BS (such as, the BS 211 or the BS 212 in FIG. 2), a master UAV UE (such as the UAV UE 204 in FIG. 2) and other UAV UEs in the UAV swarm (including the UAV UE 201, the UAV UE 202 and the UAV UE 203 in FIG. 2) in the wireless communication system in FIG. 2. The UAV UE 201, the UAV UE 202 and the UAV UE 203 in the UAV swarm may also be called a UAV UE member in a UAV swarm. In FIG. 4, the UAV UE may indicate any one of the UAV UE members in a UAV swarm (for example, any one of the UAV UE 201, the UAV UE 202 and the UAV UE 203 in FIG. 2). As discussed above, the master UAV UE has a capability to communicate with the BS, and the UAV UE member in the UAV swarm can either communicate with the master UAV UE or communicate with the BS directly.

The BS may configure each UAV UE in the UAV swarm to perform incident detection on inter-UAV spacing. In step 401, the BS may provide incident detection configuration for each UAV UE to the master UAV UE by using Uu interface, and then in step 402, the master UAV UE may provide the incident detection configuration to each UAV UE by using sidelink.

The incident detection configuration from the BS (network) to the master UAV UE can be transmitted by dedicated RRC signaling, and the incident detection configuration from the master UAV UE to the UAV UE member can be transmitted by PC5-RRC signaling or be broadcasted or groupcasted on sidelink.

The incident detection configuration may include the spacing between UAV UEs in UAV swarm. In an example, the inter-UAV spacing can be a common value among UAV UEs in the UAV swarm. In another example, the inter-UAV spacing can be a specific value to each UAV pairs in the UAV swarm. The spacing between UAVs in UAV swarm may be configured or controlled by the BS or the master UAV UE.

In addition, the incident detection configuration may further include incident detection condition(s) on inter-UAV spacing in the UAV swarm. The incident detection condition(s) on inter-UAV spacing may be configured by the BS (network) for the master UAV UE and the UAV UE member in the UAV swarm or pre-configured in the UAV UEs in the UAV swarm (including the master UAV UE).

A UAV UE may transmit an incident report to the BS directly or indirectly based on the received incident detection configuration.

In an embodiment, the master UAV UE and the UAV UE member in the UAV swarm may transmit their location information periodically by broadcast or groupcast signaling.

In another embodiment, for example, in step 403, each UAV UE member in the UAV swarm reports its location information periodically to the master UAV UE, and then in step 404, the master UAV UE transmits the location information from multiple UAV UE members to the BS.

The location information may contain coordinate of latitude, longitude, and height and velocity information. After receiving the location information, the BS may detect the incidents on spacing between UAV UEs in the UAV swarm which will be described in detail in the following.

In another embodiment, each UAV UE member may measure SL-RSRP and/or distance information between the UAV UE member itself and its neighboring UAV UEs in the UAV swarm. Each UAV UE member may transmit an incident report to the BS or the master UAV UE when at least one of the following incident detection conditions is met:
The SL-RSRP or the change of SL-RSRP between the UAV UE member itself and its neighboring UAV UE is within or outside a specified range during a time period;
The distance or the change of distance in horizontal or vertical between the UAV UE member itself and its neighboring UAV UE is within or outside a specified range during a time period; and
A sidelink radio link failure between the UAV UE member itself and its neighboring UAV UE happens (or is declared).

For example, in step 403, each UAV UE member in the UAV swarm reports an incident report to the master UAV UE, and then in step 404, the master UAV UE transmits the incident reports from multiple UAV UE members to the BS.

In this embodiment, the incident report may include the location of the UAV UE, the ID of an abnormal UAV UE and corresponding cell ID, and measurement result(s). The measurement result may include the measured SL-RSRP, the change of the SL-RSRP, the measured distance, the change of distance, or sidelink radio link failure report, etc.

In yet another embodiment, each UAV UE member may measure SL-RSRP and/or distance information between the UAV UE member itself and the master UAV UE. Each UAV UE member may transmit an incident report to the BS when at least one of the following incident detection condition is met:
The SL-RSRP or the change of SL-RSRP between the UAV UE member itself and the master UAV UE is within or outside a specified range during a time period; and
The distance or the change of distance in horizontal or vertical between the UAV UE member itself and the master UAV UE is within or outside a specified range during a time period.

In this embodiment, the incident report may include the location of the UAV UE and measurement result(s). The measurement result may include the measured SL-RSRP, the change of the SL-RSRP, the measured distance, or the change of distance, etc.

In yet another embodiment, the master UAV UE may measure SL-RSRP and/or distance information between the master UAV UE itself and the UAV UE member. The master UAV UE may transmit an incident report to the BS when at least one of the following incident detection condition is met:
The SL-RSRP or the change of SL-RSRP between the master UAV UE itself and the UAV UE member is within or outside a specified range during a time period;
The distance or the change of distance in horizontal or vertical between the master UAV UE itself and the UAV UE member is within or outside a specified range during a time period;
Incident reports are received from the UAV UE member(s) and A sidelink radio link failure between the master UAV UE itself and the UAV UE member happens (or is declared from the master UAV UE side).

In this embodiment, the incident report may include the ID of the abnormal UAV UE and corresponding cell ID, the location of the abnormal UAV UE, and measurement result(s). The measurement result may include the measured SL-RSRP, the change of the SL-RSRP, the measured distance, the change of distance, or sidelink radio link failure report, etc.

The incident report from the UAV UE member to the BS can be transmitted by RRC signaling, or be transmitted by broadcast or groupcast signaling. The incident report from the UAV UE member can be transmitted to the master UAV UE by PC5-RRC signaling, by broadcast or groupcast signaling on sidelink, or by media access control (MAC) control elements, or by sidelink physical layer control information, and the master UAV UE transmits the incident report to the BS by RRC signaling.

After receiving the incident report(s) from the UAV UE members or from the master UAV UE in the UAV swarm, the BS may assist the abnormal UAV UE(s) to perform quick recovery.

In step 405, the BS identifies the abnormal UAV UE(s) based on the received incident report(s).

In an embodiment of the present application, if the cell ID corresponding to the abnormal UAV UE in the incident report indicates the abnormal UAV UE is in the serving range of the BS, the BS transmits a recovery command to the abnormal UAV UE via the master UAV UE.

In another embodiment of the present application, if the cell ID corresponding to the abnormal UAV UE in the incident report indicates the abnormal UAV UE is not in the serving range of the BS (such as, the BS 211 in FIG. 2), the BS transmits a recovery indication to another BS (such as, the BS 212) which the abnormal UAV UE currently camped in by X2/Xn interface. The recovery indication is used to inform the serving BS (such as, the BS 212) of the abnormal UAV UE to assist the abnormal UAV UE to perform recovery.

In yet another embodiment of the present application, if the cell ID corresponding to the abnormal UAV UE in the incident report indicates the abnormal UAV UE is not in the serving range of the BS (such as, the BS 211 in FIG. 2), the BS initiates radio access network (RAN) paging or core network (CN) paging to find the abnormal UAV UE, and if the abnormal UAV UE is successfully paged in a serving range of the BS, the BS transmits a recovery command to the abnormal UAV UE.

For performing recovery to the abnormal UAV UE within its serving range when the abnormal UAV UE is identified, in step 406, the BS transmits a recovery indication which carries the ID of the abnormal UAV UE to the master UAV UE by dedicated RRC signaling and indicates the master UAV UE to transmit a recovery command to the abnormal UAV UE, and then in step 407, the master UAV UE transmits the recovery command to the abnormal UAV UE according to the recovery indication by PC5-RRC signaling, or by MAC control elements, or by sidelink physical layer control information.

In an embodiment of the present application, the recovery command may include a recovery indication to specific abnormal UAV UE. The recovery indication can either be required direction information (e.g. offset value of longitude, latitude and height), or can be required velocity information (e.g. value on deceleration or acceleration).

In another embodiment of the present application, the recovery command may include the expected positions at a specified time X, which means the abnormal UAV UE can re-join the UAV swarm if it can reach the expected position at the time X.

In yet embodiment of the present application, the recovery command may include a timer for timing trigger for location report, which may contain latitude, longitude, height and velocity information. Such a timer for a location report can be configured in the BS and the UAV UE. For example, the timer starts upon a recovery command is transmitted by the BS. The timer stops upon a location report from an abnormal UAV UE is received by the BS due to another existing trigger. Upon the timer expires, the abnormal UAV UE triggers a location report to the master UAV UE or the BS.

After receiving the recovery command, in step 408, the abnormal UAV UE performs the recovery operation according to the recovery command.

And then in step 409, when the timer expires, the abnormal UAV UE triggers a location report to the master UAV UE.

In an embodiment, in step 410, the master UAV UE transmits the location report(s) from the abnormal UAV UE(s) to the BS. In step 413, after receiving the location report, the BS may determine whether the recovery is successful or not. In an example, the location report indicates the abnormal UAV UE is in the expected position in the UAV swarm, and the BS may determine the recovery is successful; otherwise the BS may determine the recovery is unsuccessful.

In another embodiment of the present application, the master UAV UE may determine whether the recovery is successful or not. For example, in step 411, the master UAV UE may measure the SL-RSRP between the master UAV UE itself and the abnormal UAV UE and determine whether the SL-RSRP is within a normal range. If the SL-RSRP is within a normal range, the master UAV UE may determine the recovery is successful; otherwise the master UAV UE may determine the recovery is unsuccessful. In another example, in step 411, the master UAV UE receives the location report which indicates the abnormal UAV UE is in the expected position in the UAV swarm and determines the recovery is successful. And then in step 412, the master UAV UE may transmit the recovery result to the BS.

In some cases, for example, the abnormal UAV UE receives the recovery command but cannot perform the recovery operation, for example, due to current capability limitation. In another example, the abnormal UAV UE cannot receive the recovery command from the master UAV UE, for example, due to the occurred incident.

In these cases, the timer for the location report (which is the same timer as that included in the recovery command) can be triggered, and the BS may transmit an incident indication to inform the UAV swarm about the incident of the abnormal UAV UE when the timer expires and no location report is received. The incident indication may include the ID of the abnormal UAV UE, location information of the abnormal UAV UE, and an indication to clear the transmission with the abnormal UAV UE. In another example, the BS may inform application layer for the UAV swarm about the incident indication. The incident indication from the BS to the UAV swarm can be broadcasted by SIB signaling or be transmitted by RRC signaling. In another embodiment, the incident indication can also be transmitted to the master UAV UE by RRC signaling, and the master UAV UE transmits the incident indication to the UAV UEs in the UAV swarm by PC5-RRC signaling or by broadcast or groupcast signaling on sidelink.

Furthermore, if the number of incidents on inter-UAV spacing occurred in the same UAV UE reaches to a specified value, the BS may inform application layer to drop out the UAV UE.

The embodiments of the present application can make the incident detection and recovery on inter-UAV spacing in the UAV swarm more efficiently from AS layer.

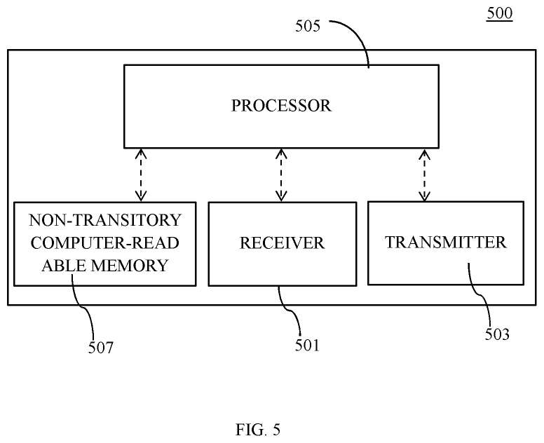

FIG. 5 illustrates an apparatus according to some embodiments of the present application. In some embodiments of the present disclosure, the apparatus 500 may be the UAV UE 101, UAV UE 102, or UAV UE 103 as illustrated in FIG. 1, the UAV UE 201, UAV UE 202, UAV UE 203, or UAV UE 204 as illustrated in FIG. 2 or other embodiments of the present application.

As shown in FIG. 5, the apparatus 500 may include a receiver 501, a transmitter 503, a processer 505, and a non-transitory computer-readable medium 507. The non-transitory computer-readable medium 507 has computer executable instructions stored therein. The processer 505 is configured to be coupled to the non-transitory computer readable medium 507, the receiver 501, and the transmitter 503. It is contemplated that the apparatus 500 may include more computer-readable mediums, receiver, transmitter and processors in some other embodiments of the present application according to practical requirements. In some embodiments of the present application, the receiver 501 and the transmitter 503 are integrated into a single device, such as a transceiver. In certain embodiments, the apparatus 500 may further include an input device, a memory, and/or other components.

In some embodiments of the present application, the non-transitory computer-readable medium 507 may have stored thereon computer-executable instructions to cause a processor to implement the method according to embodiments of the present application.

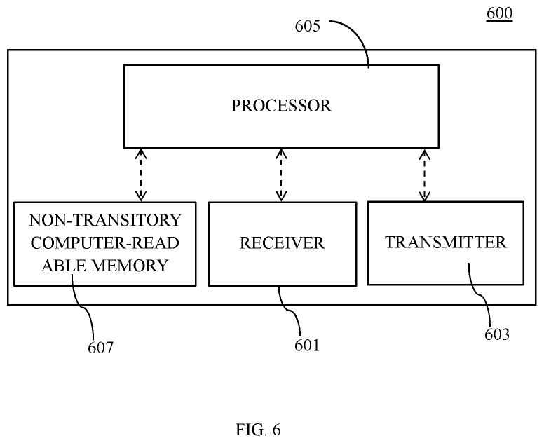

FIG. 6 illustrates another apparatus according to some embodiments of the present application. In some embodiments of the present disclosure, the apparatus 600 may be the BS 111 or the BS 112 as illustrated in FIG. 1, the BS 211 or the BS 212 as illustrated in FIG. 2 or other embodiments of the present application.

As shown in FIG. 6, the apparatus 600 may include a receiver 601, a transmitter 603, a processer 605, and a non-transitory computer-readable medium 607. The non-transitory computer-readable medium 607 has computer executable instructions stored therein. The processer 605 is configured to be coupled to the non-transitory computer readable medium 607, the receiver 601, and the transmitter 603. It is contemplated that the apparatus 600 may include more computer-readable mediums, receiver, transmitter and processors in some other embodiments of the present application according to practical requirements. In some embodiments of the present application, the receiver 601 and the transmitter 603 are integrated into a single device, such as a transceiver. In certain embodiments, the apparatus 600 may further include an input device, a memory, and/or other components.

In some embodiments of the present application, the non-transitory computer-readable medium 607 may have stored thereon computer-executable instructions to cause a processor to implement the method according to embodiments of the present application.

Persons skilled in the art should understand that as the technology develops and advances, the terminologies described in the present application may change, and should not affect or limit the principle and spirit of the present application.

Those having ordinary skill in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1. An apparatus, comprising:
a memory; and
a processor coupled to the memory, the processor configured to cause the apparatus to:
transmit one or more incident reports; and
perform, if a recovery command for a first unmanned aerial vehicle (UAV) user equipment (UE) of a UAV swarm the is received, a recovery operation according to a recovery command.

2. The apparatus of claim 1, wherein each incident report comprises at least one of:
a location of the first UAV UE;
a first ID of the first UAV UE;
a distance between the first UAV UE and a second UAV UE in a the UAV swarm;
sidelink power received by the first UAV UE from the second UAV UE;
a second ID of the second UAV UE; and
a cell ID of the second UAV UE.

3. The apparatus of claim 2, wherein the second UAV UE comprises one or more of a neighboring UAV UE of the first UAV UE, a member UAV UE in the UAV swarm or a master UAV UE in the UAV swarm.

4. The apparatus of claim 2, wherein the processor is configured to cause the apparatus to transmit the one or more incident reports when an incident detection condition is met, and the incident detection condition comprises at least one of:
the received sidelink power or a change of the received sidelink power is out of a first specified range;
the distance between the first UAV UE and the second UAV UE or a change of the distance is out of a second specified range; or
a sidelink radio link failure between the first UAV UE and the second UAV UE happens.

5. The apparatus of claim 1, wherein the processor is configured to cause the apparatus to:
receive an incident detection configuration from one or more of a master UAV UE or a base station (BS).

6. The apparatus of claim 1, wherein the processor is configured to cause the apparatus to:
transmit a location report after performing the recovery operation.

7. The apparatus of claim 1, wherein the processor is configured to cause the apparatus to:
receive an incident detection configuration for one or more UAV UEs in the UAV swarm from a base station (BS);
receive the one or more incident reports from the one or more UAV UEs in the UAV swarm;
receive a recovery indication indicating an abnormal UAV UE in the UAV swarm from the BS; and
transmit a recovery command to the abnormal UAV UE based on the recovery indication.

8. The apparatus of claim 7, wherein the recovery command comprises at least one of:
at least one of a direction information and a velocity information for the abnormal UAV UE;
an expected position for the abnormal UAV UE; or
a timing trigger for the abnormal UAV UE to transmit a location report.

9. The apparatus of claim 8, wherein the processor is configured to cause the apparatus to:
receive the location report from the abnormal UAV UE in response to the recovery command; and
transmit the location report to the BS.

10. The apparatus of claim 8, wherein the processor is configured to cause the apparatus to:
determine whether recovery of the abnormal UAV UE is successful based on at least one of a measured sidelink power received by the first UAV UE from the abnormal UE or the received incident report; and
transmit a recovery result to the BS.

11. An apparatus, comprising:
a memory; and
a processor coupled to the memory, the processor configured to cause the apparatus to:
receive, at a first base station (BS), one or more incident reports of one or more unmanned aerial vehicle (UAV) user equipment (UE) in a UAV swarm; and
identify an abnormal UAV UE in the UAV swarm based on the one or more incident reports.

12. The apparatus of claim 11, wherein the one or more incident reports are received from one or more UAV UE directly or via a master UAV UE.

13. The apparatus of claim 11, wherein an incident report of a first UAV UE among the one or more incident reports comprises at least one of:
a location of the first UAV UE;
a first ID of the first UAV UE;
a distance between the first UAV UE and a second UAV UE in the UAV swarm;
sidelink power received by the first UAV UE from the second UAV UE;
a second ID of the second UAV UE; or
a cell ID of the second UAV UE.

14. The apparatus of claim 11, wherein the processor is configured to cause the apparatus to:
transmit a recovery command to the abnormal UAV UE by radio resource control (RRC) signaling.

15. The apparatus of claim 11, wherein the processor is configured to cause the apparatus to:
transmit a recovery indication indicating the abnormal UAV UE to a second BS, if the abnormal UAV UE is in a serving range of the second BS.

16. The apparatus of claim 11, wherein the processor is configured to cause the apparatus to:
initiate radio access network (RAN) paging or core network (CN) paging to find the abnormal UAV UE; and
transmit a recovery command to the abnormal UAV UE if the abnormal UAV UE is successfully paged in a serving range of the first BS.

17. The apparatus of claim 11, wherein the processor is configured to cause the apparatus to:
transmit a recovery indication indicating the abnormal UAV UE to a master UAV UE.

18. The apparatus of claim 14, wherein one or more of the recovery command or a recovery indication comprises at least one of the following:
at least one of direction information and velocity information for the abnormal UAV UE;
an expected positions for the abnormal UAV UE; or
a timing trigger for the abnormal UAV UE to transmit a location report.

19. The apparatus of claim 18, wherein the processor is configured to cause the apparatus to:
receive the location report of the abnormal UAV UE; and
determine whether recovery of the abnormal UAV UE is successful.

20. (canceled)

21. (canceled)

22. (canceled)

23. (canceled)

24. A method comprising:
transmitting one or more incident reports; and
perform, if a recovery command for a first unmanned aerial vehicle (UAV) user equipment (UE) of a UAV swarm is received, a recovery operation according to a recovery command.
